(19) United States
(12) Patent Application Publication
(10) Pub. No.: US 2011/0151315 A1
(43) Pub. Date: Jun. 23, 2011

(54) BUS BAR ASSEMBLY

(75) Inventors: Olivier Masson, St. Vincent de Paul (FR); Sebastien Teyssonnier, Bordeaux (FR)

(73) Assignee: Johnson Controls - SAFT Advanced Power Solutions LLC

(21) Appl. No.: 13/058,322

(22) PCT Filed: Aug. 10, 2009
(86) PCT No.: PCT/US2009/053282

§ 371 Date: Feb. 9, 2011

Related U.S. Application Data
(60) Provisional application No. 61/087,971, filed on Aug. 11, 2008.

(51) Int. Cl. H01M 10/02; H01M 2/30; H01R 43/00; H01B 5/02

(52) U.S. Cl. 429/159; 29/884; 174/126.1

(57) ABSTRACT

A bus bar assembly includes a flexible member comprising a plurality of apertures provided therein. The bus bar assembly also includes a plurality of electrically conductive members coupled to the flexible member. Each of the plurality of conductive members includes an aperture that is aligned with one of the apertures of the flexible member such that the bus bar assembly is configured for electrically coupling a plurality of electrochemical cells together when at least one terminal of each of the cells is received within an aperture of the flexible member and an associated aperture of one of the plurality of conductive members.

### CROSS-REFERENCE TO RELATED PATENT APPLICATIONS

This application claims the benefit of and priority to U.S. Provisional Patent Application No. 61/087,971, filed Aug. 11, 2008, the entire disclosure of which is incorporated herein by reference.

### BACKGROUND

The present application relates generally to the field of batteries and battery systems. More specifically, the present application relates to batteries and battery systems that may be used in vehicle applications to provide at least a portion of the motive power for the vehicle.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case with certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It would also be desirable to provide a battery module and/or system that includes any one or more of the advantageous features that will be apparent from a review of the present disclosure.

### SUMMARY

According to an exemplary embodiment, a bus bar assembly includes a flexible member including a plurality of apertures provided therein. The bus bar assembly also includes a plurality of electrically conductive members coupled to the flexible member. Each of the plurality of conductive members includes an aperture that is aligned with one of the apertures of the flexible member such that the bus bar assembly is configured for electrically coupling a plurality of electrochemical cells together when at least one terminal of each of the cells is received within an aperture of the flexible member and an associated aperture of one of the plurality of conductive members.

According to another exemplary embodiment, a battery system includes a plurality of electrochemical cells and a plurality of conductive members coupled to a flexible substrate. Each conductive member is configured to electrically couple a terminal of one electrochemical cell to a terminal of another electrochemical cell. The flexible substrate is configured to flex to reduce the tendency of the conductive members to decouple from the terminals of the electrochemical cells.

According to another exemplary embodiment, a method of manufacturing a battery system includes providing a plurality of electrochemical cells, each of the plurality of electrochemical cells comprising at least one terminal extending from an end thereof. The method also includes providing a bus bar assembly comprising a flexible member and a plurality of electrically conductive bus bars coupled to a surface of the flexible member, each of the bus bars including at least one aperture aligned with a corresponding aperture in the flexible member. The method further includes electrically connecting the plurality of electrochemical cells together by inserting each of the terminals of the plurality of electrochemical cells through an associated aperture in the flexible member and a corresponding aperture in one of the plurality of bus bars.

### BRIEF DESCRIPTION OF THE DRAWINGS

FIG. 1 is a perspective view of a vehicle including a battery module according to an exemplary embodiment.

FIG. 2 is a cutaway schematic view of a vehicle provided including a battery module according to an exemplary embodiment.

FIG. 3 is a top view of a portion of a battery pack or module according to an exemplary embodiment.

FIG. 4 is a schematic view showing the conductive path of the battery module of FIG. 3 according to an exemplary embodiment.

FIGS. 5 and 6 are isometric views of an electrochemical cell for the battery module of FIG. 3 according to an exemplary embodiment.

FIG. 7 is a top view of the battery module of FIG. 3 showing a structural member surrounding the cells according to an exemplary embodiment.

FIG. 8 is an isometric view of a bus bar member configured to electrically couple together a plurality of cells in the battery module of FIG. 3 according to an exemplary embodiment.

FIG. 9 is a bottom view of the bus bar member of FIG. 8.

FIG. 10 is a cross-section of the bus bar member of FIG. 9 taken along line 10-10 of FIG. 9.

FIG. 11 is a top view of the bus bar member of FIG. 8 having a plurality of conductive members coupled thereto according to an exemplary embodiment.

FIG. 12 is a top view of the bus bar member of FIG. 8 showing a plurality of leads according to an exemplary embodiment.

FIG. 13 is a cross-section of the bus bar member of FIG. 12 taken along line 13-13 of FIG. 12.

FIG. 14 is a cross-section of the bus bar member of FIG. 12 taken along line 14-14 of FIG. 12.

FIG. 15 is a schematic figure of a portion of a bus bar member showing several exemplary placements of a temperature sensor according to an exemplary embodiment.

FIG. 16 is a top view of a portion of the bus bar member of FIG. 8 showing a plurality of contacts according to an exemplary embodiment.

FIG. 17 is a perspective view of a connector coupled to a contact on the bus bar member of FIG. 8 according to an exemplary embodiment.

### DETAILED DESCRIPTION

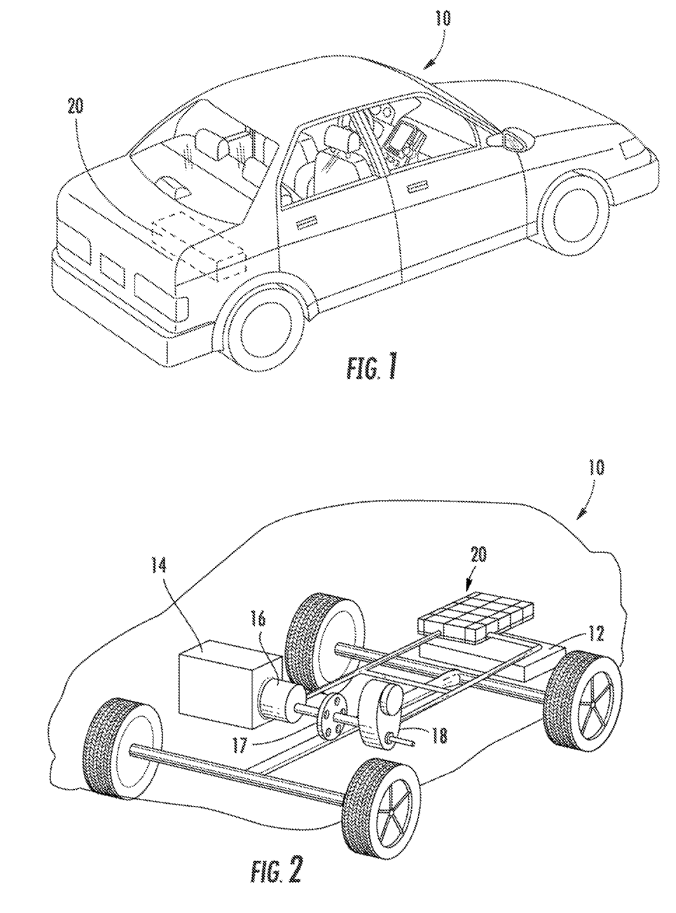

FIG. 1 is a perspective view of a vehicle 10 in the form of an automobile (e.g., a car) having a battery system 20 for providing all or a portion of the motive power for the vehicle 10. Such a vehicle 10 can be an electric vehicle (EV), a hybrid electric vehicle (HEV), a plug-in hybrid electric vehicle (PHEV), or other type of vehicle using electric power for propulsion (collectively referred to as “electric vehicles”).

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery system 20 is illustrated in FIG. 1 as being positioned in the trunk or rear of the vehicle, according to other exemplary embodiments, the location of the battery system 20 may differ. For example, the position of the battery system 20 may be selected based on the available space within a vehicle, the desired weight balance of the vehicle, the location of other components used with the battery system 20 (e.g., battery management systems, vents or cooling devices, etc.), and a variety of other considerations.

FIG. 2 illustrates a cutaway schematic view of a vehicle 10 provided in the form of an HEV according to an exemplary embodiment. A battery system 20 is provided toward the rear of the vehicle 10 proximate a fuel tank 12 (the battery system 20 may be provided immediately adjacent the fuel tank 12 or may be provided in a separate compartment in the rear of the vehicle 10 (e.g., a trunk) or may be provided elsewhere in the vehicle 10). An internal combustion engine 14 is provided for times when the vehicle 10 utilizes gasoline power to propel the vehicle 10. An electric motor 16, a power split device 17, and a generator 18 are also provided as part of the vehicle drive system. Such a vehicle 10 may be powered or driven by just the battery system 20, by just the engine 14, or by both the battery system 20 and the engine 14. It should be noted that other types of vehicles and configurations for the vehicle electrical system may be used according to other exemplary embodiments, and that the schematic illustration of FIG. 2 should not be considered to limit the scope of the subject matter described in the present application.

According to various exemplary embodiments, the size, shape, and location of the battery system 20, the type of vehicle 10, the type of vehicle technology (e.g., EV, HEV, PHEV, etc.), and the battery chemistry, among other features, may differ from those shown or described.

According to an exemplary embodiment, the battery system 20 is responsible for packaging or containing electrochemical batteries or cells 24, connecting the electrochemical cells 24 to each other and/or to other components of the vehicle electrical system, and regulating the electrochemical cells 24 and other features of the battery system 20. For example, the battery system 20 may include features that are responsible for monitoring and controlling the electrical performance of the battery system 20 (e.g., with a battery management system 32), managing the thermal behavior of the battery system 20, containment and/or routing of effluent (e.g., gases that may be vented from a cell 24), and other aspects of the battery system 20.

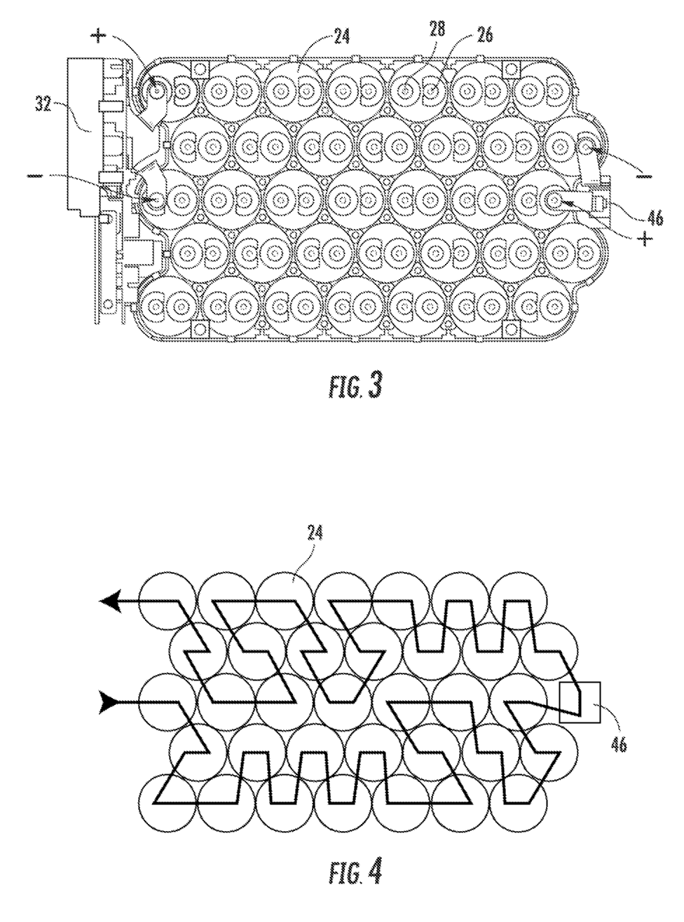

Referring now to FIG. 3, a top view of a portion of a battery pack or battery module 22 for the battery system 20 is shown according to an exemplary embodiment. The battery module 22 includes a plurality of electrochemical cells 24 (e.g., lithium-ion cells, nickel-metal-hydride cells, lithium polymer cells, etc., or other types of electrochemical cells now known or hereafter developed). Each of the cells 24 is electrically coupled to one or more other cells 24 or other components of the battery system 20 using connectors provided in the form of bus bars or similar conductive elements to form a conductive path (e.g., such as shown in FIG. 4). According to other exemplary embodiments, the conductive path may differ from that shown in FIG. 4.

Although illustrated in FIGS. 3-4 as having a particular number of electrochemical cells (i.e., five offset rows of electrochemical cells arranged such that seven cells are arranged in each row, for a total of thirty-five electrochemical cells), it should be noted that according to other exemplary embodiments, a different number and/or arrangement of electrochemical cells may be used depending on any of a variety of considerations (e.g., the desired power for the battery system, the available space within which the battery system must fit, etc.).

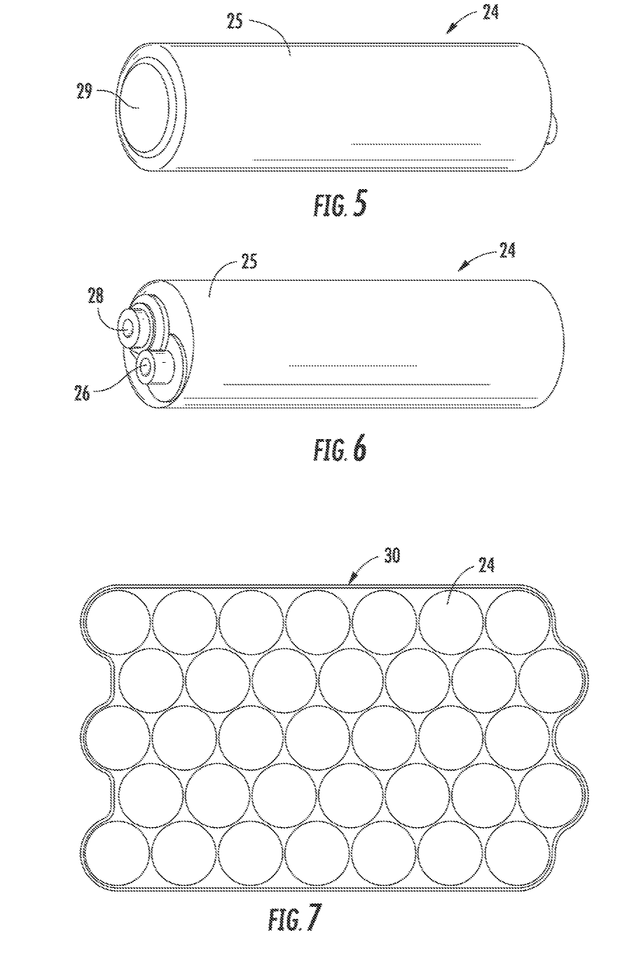

Referring to FIGS. 5-6, according to an exemplary embodiment, the electrochemical cells 24 are generally cylindrical lithium-ion cells 24 configured to store an electrical charge. The cells 24 include a cylindrical housing 25 having a positive terminal 26 and a negative terminal 28 on one end and a vent 29 on an opposite end. According to other exemplary embodiments, cells 24 could have other physical configurations (e.g., oval, prismatic, polygonal, etc.). The capacity, size, design, terminal configuration, and other features of the cells 24 may also differ from those shown according to other exemplary embodiments.

According to an exemplary embodiment, one or more members or elements in the form of trays or similar structures (not shown) are provided to maintain the cells 24 in fixed relation to each other. The trays may be made of a polymeric material or other suitable materials (e.g., electrically insulative materials). The trays may also include features to provide spacing of the cells 24 away from the surface of the trays and/or from adjacent cells 24. For example, according to an exemplary embodiment, the trays may include a series of ribs or protrusions that act to provide a space for a cooling or heating fluid (e.g., a gas) to flow around the outer surfaces of the cells 24. A cover (not shown) and/or a base plate (not shown) may be provided to partially or completely surround or enclose the cells 24 and the trays.

Referring now to FIG. 7, a structural member 30 in the form of a belt (e.g., a strap, restraint, band, etc.) may be included in addition to or in place of the trays. According to an exemplary embodiment, the structural member 30 is configured to arrange and/or maintain the cells 24 in fixed relation to each other. According to an exemplary embodiment, the structural member 30 may extend over substantially the entire height of the cells 24. According to other exemplary embodiments, the structural member 30 may extend only over a portion of the height of the cells 24. For example, the structural member 30 may extend over a middle portion, a top portion, or a bottom portion of the height of the cells 24. According to another exemplary embodiment, more than one structural member 30 may be utilized (e.g., a first structural member 30 may extend over a top portion of the height of the cells 24 and a second structural member may extend over a bottom portion of the height of the cells 24).

As shown in FIG. 7, according to an exemplary embodiment, the structural member 30 is configured to substantially follow the external contour or external perimeter of the offset rows of cells 24 in order to maintain the cells 24 in fixed relation to one another. According to other exemplary embodiments, the structural member 30 may otherwise be configured (e.g., the structural member 30 may comprise generally straight sides). According to an exemplary embodiment, the structural member 30 may be formed of aluminum or an aluminum alloy, and according to other exemplary embodiments, other suitable materials may be used for the structural member 30.

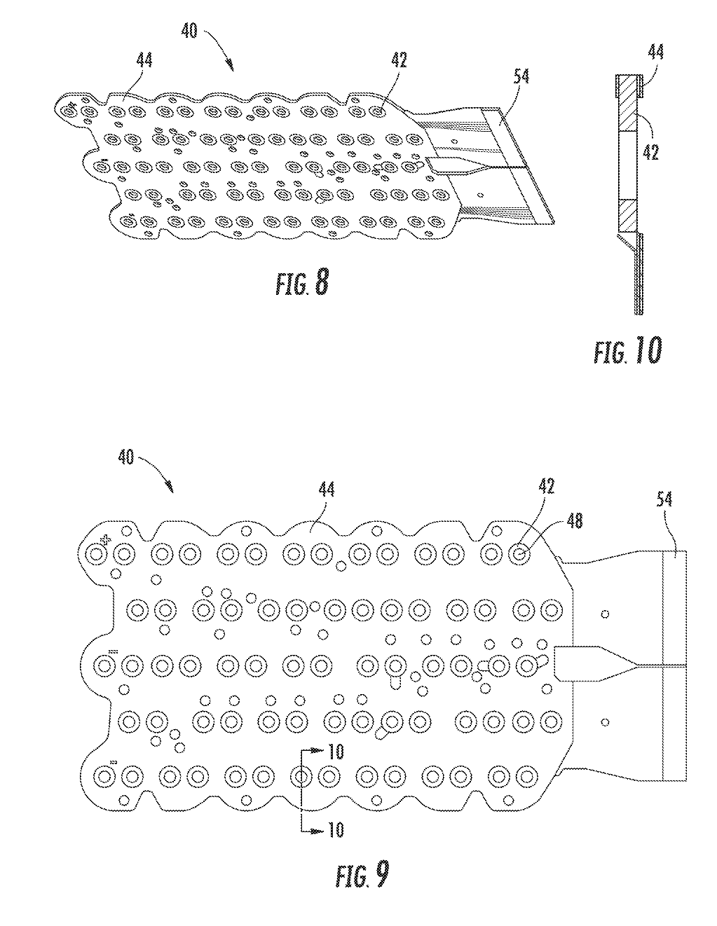

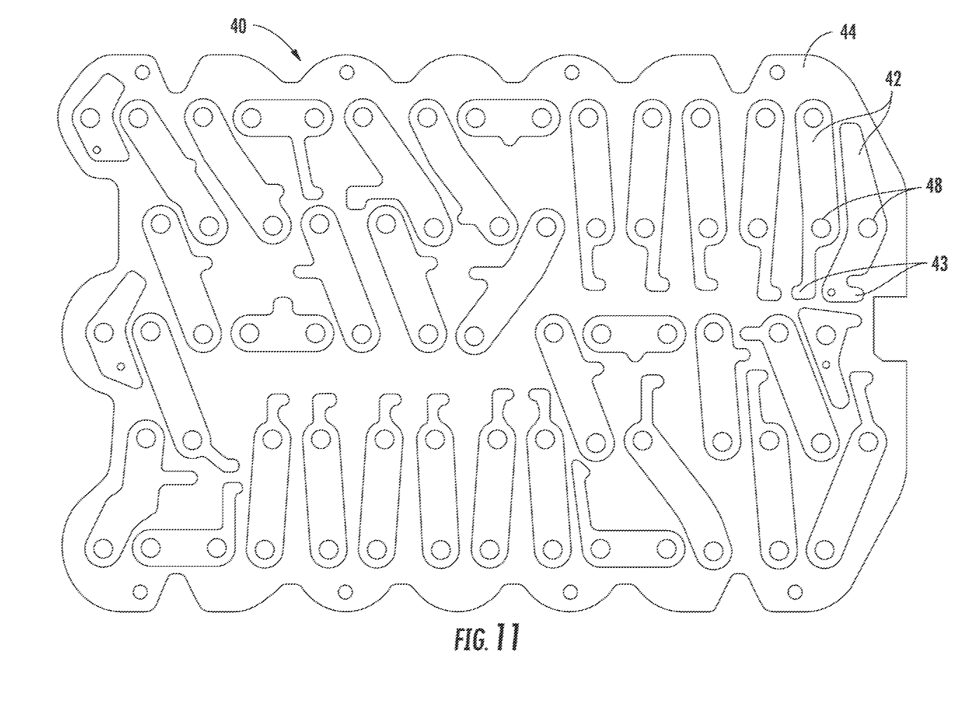

Referring now to FIGS. 8-17, a bus bar assembly 40 is described according to an exemplary embodiment. The bus bar assembly 40 includes a number of conductive members or elements 42. The conductive members 42 are mounted on or coupled (e.g., by an adhesive) to a flexible member or element in the form of a plate or substrate (hereinafter referred to as substrate 44). Because all of the conductive members 42 are provided on the substrate 44, all of the conductive members 42 may be positioned in contact with the terminals 26, 28 of the associated cells 24 substantially simultaneously, which is intended to reduce the amount of time and effort required to assemble the battery module 22.

According to an exemplary embodiment, the substrate 44 of the bus bar assembly 40 is a generally flexible member. According to another exemplary embodiment, only a portion of the substrate 44 is flexible. According to an exemplary embodiment, the substrate 44 is a flexible film having a thickness in the range of approximately 25 μm-500 μm (e.g., 50 μm). According to one exemplary embodiment, the substrate 44 is configured to flex (e.g., bend, adjust, move, etc.) during assembly or in operation (e.g., when subjected to vibrational forces).

One advantage of having a flexible substrate 44 is that it allows the bus bar assembly 40 to accommodate variances in the heights of the cells 24 and cell terminals 26, 28 (e.g., due to manufacturing and/or assembly stack-up tolerances). Being able to accommodate these variances allows the bus bar assembly 40 to provide relatively good electrical contact between the conductive members 42 and the terminals 26, 28. Another advantage of having a flexible substrate 44 is that it allows the bus bar assembly 40 to dampen any vibrational forces that the battery system 20 may be subjected to and/or flex to reduce the tendency of the conductive members 42 to decouple from the terminals 26, 28 of the cells 24.

According to an exemplary embodiment, the substrate 44 is formed from a non-conductive material such as a polymer (e.g., polyethylene naphthalate, polyimide, or any other suitable material). According to another exemplary embodiment, the substrate 44 is configured to be fireproof and self-extinguishable.

According to an exemplary embodiment, the conductive members 42 of the bus bar assembly 40 form contact areas on either end of the conductive members 42 that are aligned with the terminals 26, 28 of the cells 24 (or with other components, such as, e.g., a fuse 46). Apertures or openings 48 are provided at each end of the conductive members 42 that are aligned with apertures or openings provided in the substrate 44 and are configured to receive the terminals 26, 28. According to an exemplary embodiment, a fastener (e.g., screw, bolt, etc.) (not shown) is used to couple the conductive members 42 to one terminal of a first cell 24 to one terminal of a second cell 24 (or other component).

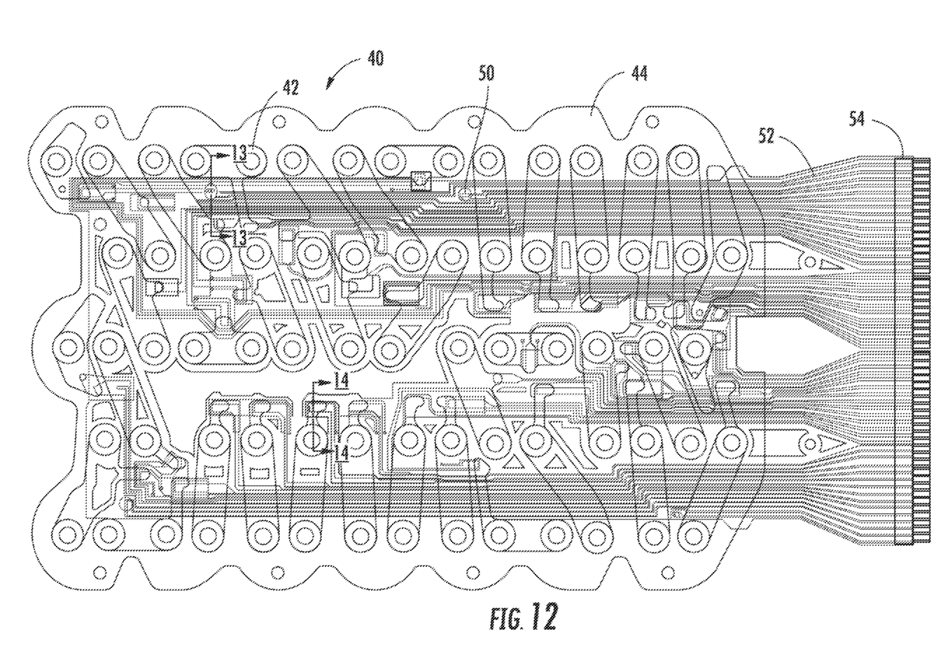

According to an exemplary embodiment, the openings 48 are generally circular holes but may have other configurations (e.g., slots, ovals, etc.). According to an exemplary embodiment, the openings 48 have a diameter of approximately 5.5 mm, but may differ more or less according to other exemplary embodiments. According to an exemplary embodiment, the conductive members 42 have a cross-section of at least 25 mm², but may differ more or less according to other exemplary embodiments. According to an exemplary embodiment, the conductive members 42 have a thickness of approximately 2 mm and a width of approximately 12.5 mm. According to other exemplary embodiments, the conductive members 42 may have different widths and/or thicknesses. As shown, for example, in FIG. 11, conductive members 42 are provided in many different shapes and sizes. According to other exemplary embodiments, these shapes and sizes may differ from that shown.

According to an exemplary embodiment, the conductive members 42 are formed of copper or another suitable conductive material. According to another exemplary embodiment, the conductive members 42 are formed from a tinned (e.g., tin-plated) copper material to more efficiently coupled (e.g., solder) voltage sense leads to the conductive members 42. According to other exemplary embodiments, the conductors 42 may include tin-plating only near the ends of the conductive members 42. For example, the tin-plating may be located only in the area of the contacts adjacent the openings 48 or at a tip 43 (end, point, contact, etc), with no tin-plating located near the middle of the conductive members 42.

According to an exemplary embodiment, the bus bar assembly 40 also includes a plurality of sensors (e.g., voltage sensors, current sensors, temperature sensors, etc.) and leads 52 (e.g., lead lines, etc.) that are configured to transmit a signal from the sensors to a component such as a cell supervisory controller (CSC) (not shown). In this manner, both the conductive members 42 and the plurality of sensors may be provided as a single preassembled unit that may then be assembled to the cells 24 of the battery module 22 in a single operation.

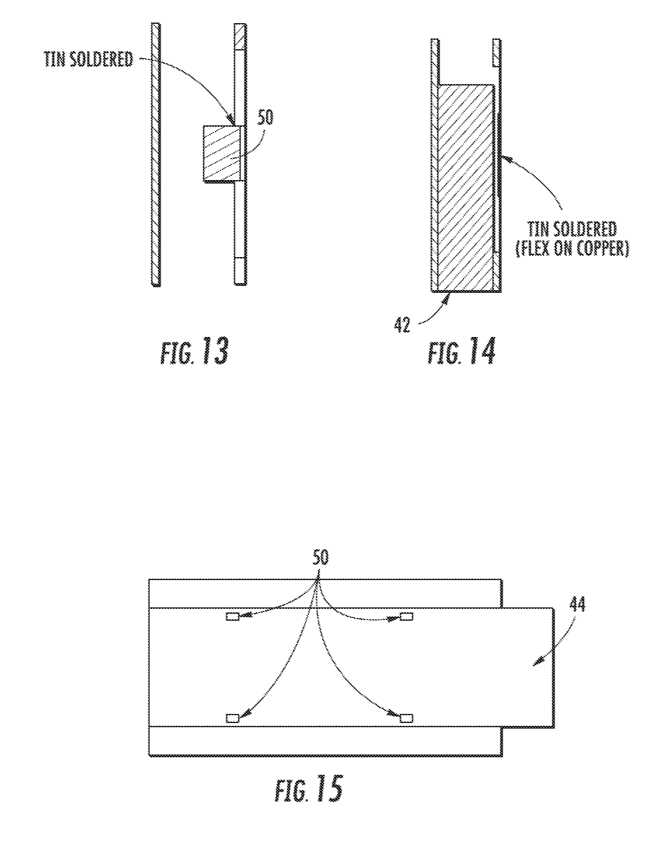

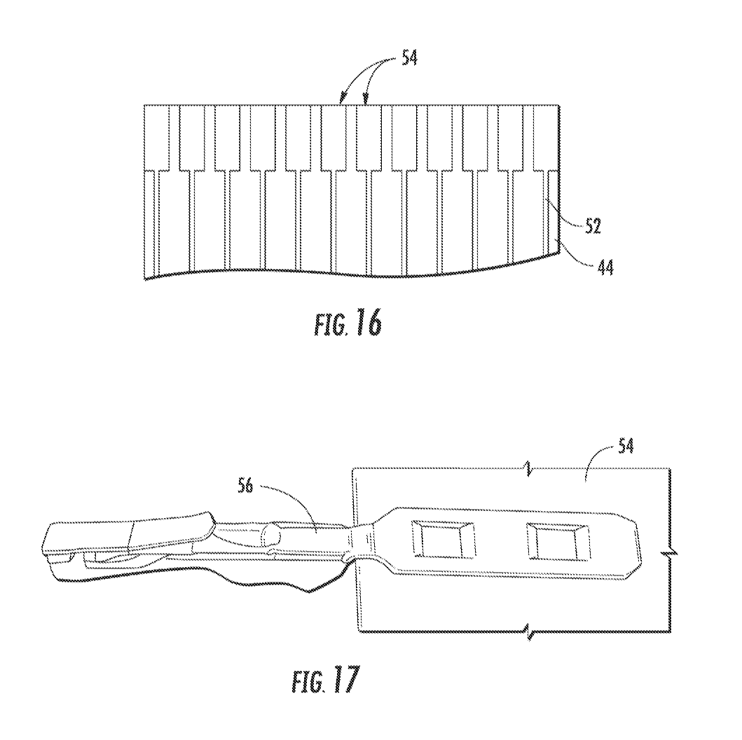

According to an exemplary embodiment, the bus bar assembly 40 includes a plurality (e.g., four temperature sensors 50) provided at various locations on bus bar assembly 40 (see, e.g., FIGS. 13 and 15). According to other exemplary embodiments, more or fewer temperature sensors 50 may be provided. According to an exemplary embodiment, the temperature sensors 50 are embedded in or otherwise coupled to the substrate 44. According to an exemplary embodiment, the temperature sensors 50 are insulated against cooling or heating air/fluid in order to avoid inaccurate measurements.

According to an exemplary embodiment, each temperature sensor 50 is positioned to measure the temperature of a cell and is positioned at or near the top of one of the terminals of the cell. Because the terminal is mechanically and electrically connected to the cell element inside the cell, the approximate temperature inside the cell can be estimated. If the cell begins to overheat, the battery module may be shut down, the current through the cell may be reduced, or other preventative measures may be taken to prevent additional damage to the battery module.

According to an exemplary embodiment, the plurality of leads 52 are provided on or otherwise coupled to the bus bar assembly 40. According to one exemplary embodiment, a portion of the plurality of leads 52 are coupled to the conductive members 42 for voltage measurement or are coupled to the temperature sensors 50. According to another exemplary embodiment, a portion of the plurality of leads 52 are for alimentation of a printed circuit board (PCB) card (not shown).

According to an exemplary embodiment, the leads 52 are spaced apart to provide adequate insulation between adjacent leads 52. For example, the leads 52 may be spaced apart at least approximately 1 mm, but may vary according to other exemplary embodiments. According to another exemplary embodiment, the leads 52 may be coupled to the conductive members 42 and/or sensors with a welding or soldering operation.

According to an exemplary embodiment, each of the leads 52 couple one of the conductive members 42 and/or the sensors to a sensor contact 54 (e.g., as shown in FIG. 16). According to an exemplary embodiment, the sensor contact 54 comprises a contact area substantially larger than the lead 52. According to one exemplary embodiment, the width of the sensor contact 54 is at least 1.5 mm and the length at least 6 mm, but may vary in both width and length according to other exemplary embodiments. According to an exemplary embodiment, the portion of the substrate 44 comprising the sensor contacts 54 is configured to be able to be coupled to the PCB card (e.g., provided above the bus bar assembly 40). According to an exemplary embodiment, the leads 52 are provided on the substrate 44 in an orderly fashion in order to efficiently connect the plurality of sensors to the PCB card or the controller.

According to another exemplary embodiment, the sensor contacts 54 are coupled to other members with connectors 56 (e.g., as shown in FIG. 17). According to one exemplary embodiment, the connector 56 is coupled to the sensor contact 54 by piercing the sensor contact 54. For example, according to an exemplary embodiment, the connector 56 may pierce the sensor contact 54 at multiple points (e.g., at four points, but may vary according to other exemplary embodiments). According to other exemplary embodiments, the connector 56 may be otherwise coupled to the sensor contact 54 (e.g., by welding, soldering, etc.).

According to an exemplary embodiment, a bus bar assembly for use in electrically coupling a plurality of cells together in a battery module includes a flexible member having a plurality of conductive members coupled thereto. The flexible member includes a plurality of apertures or holes provided therein that are aligned with apertures or holes provided in the conductive members. Terminals of cells are configured to extend through the holes in the flexible members and the conductive members to couple the cells together to form a battery module. According to an exemplary embodiment, the conductive members are coupled to the flexible member prior to coupling the bus bar assembly to a plurality of electrochemical cells such that all of the conductive members may be substantially simultaneously coupled to the electrochemical cells.

According to another exemplary embodiment, a method of manufacturing a battery system includes a first step of providing a plurality of electrochemical cells. Each cell has at least one terminal extending from an end thereof. A second step includes providing a flexible member having a plurality of apertures provided therein. A third step includes coupling a plurality of bus bars to the flexible member. Each bus bar has an aperture that is aligned with one of the apertures of the flexible member such that the at least one terminal of one of the electrochemical cells is received by the aperture of the bus bar and the aperture of the flexible member. According to another exemplary embodiment, the plurality of bus bars are coupled to the flexible member prior to coupling the flexible member to the plurality of electrochemical cells such that all of the conductive members may be substantially simultaneously coupled to the electrochemical cells.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the bus bar assembly as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A bus bar assembly comprising:
a flexible member comprising a plurality of apertures provided therein; and
a plurality of electrically conductive members coupled to the flexible member, each of the plurality of conductive members comprising an aperture that is aligned with one of the apertures of the flexible member;
wherein the bus bar assembly is configured for electrically coupling a plurality of electrochemical cells together when at least one terminal of each of the cells is received within an aperture of the flexible member and an associated aperture of one of the plurality of conductive members.

2. The bus bar assembly of claim 1, wherein the plurality of conductive members are coupled to the flexible member prior to coupling the bus bar assembly to a plurality of electrochemical cells such that all of the conductive members may be substantially simultaneously coupled to terminals of the electrochemical cells.

3. The bus bar assembly of claim 1, wherein the flexible member is formed from a non-conductive material selected from the group consisting of polyethylene naphthalate and polyimide.

4. The bus bar assembly of claim 1, wherein each of the plurality of conductive members is formed from a copper material.

5. The bus bar assembly of claim 4, wherein the copper material is tin-plated.

6. The bus bar assembly of claim 4, wherein the copper material is tin-plated only at an end of the conductive member.

7. The bus bar assembly of claim 1, further comprising at least one sensor coupled to the flexible member.

8. The bus bar assembly of claim 1, further comprising at least one temperature sensor embedded in the flexible member.

9. The bus bar assembly of claim 8, further comprising at least one lead line configured to connect the at least one temperature sensor to a controller.

10. The bus bar assembly of claim 1, wherein the flexible member comprises a flexible portion that is 50 μm thick.

11. A battery system comprising a plurality of electrochemical cells and further comprising:
a plurality of conductive members coupled to a flexible substrate, each conductive member configured to electrically couple a terminal of one electrochemical cell to a terminal of another electrochemical cell, the flexible substrate configured to flex to reduce the tendency of the conductive members to decouple from the terminals of the electrochemical cells.

12. The battery system of claim 11, wherein the plurality of conductive members are coupled to the flexible member prior to installation in the battery system such that all of the conductive members may be substantially simultaneously coupled to the terminals of the electrochemical cells of the battery system.

13. The battery system of claim 11, further comprising a plurality of sensors coupled to the flexible member.

14. The battery system of claim 11, further comprising a belt provided around an external perimeter of the plurality of electrochemical cells and configured to physically maintain the electrochemical cells in relationship with one another.

15. A method of manufacturing a battery system comprising:
providing a plurality of electrochemical cells, each of the plurality of electrochemical cells comprising at least one terminal extending from an end thereof;
providing a bus bar assembly comprising a flexible member and a plurality of electrically conductive bus bars coupled to a surface of the flexible member, each of the bus bars including at least one aperture aligned with a corresponding aperture in the flexible member; and
electrically connecting the plurality of electrochemical cells together by inserting each of the terminals of the plurality of electrochemical cells through an associated aperture in the flexible member and a corresponding aperture in one of the plurality of bus bars.

16. The method of claim 15, wherein the plurality of bus bars are coupled to the flexible member prior to coupling the flexible member to the terminals of the electrochemical cells such that all the bus bars may be substantially simultaneously coupled to the terminals of the electrochemical cells.

17. The method of claim 16, wherein the bus bar assembly further comprises a plurality of sensors coupled to the flexible member.

18. The method of claim 17, further comprising electrically connecting the plurality of sensors to a controller.

19. The method of claim 18, wherein each of the plurality of sensors are coupled to the controller by a lead line.

20. The method of claim 19, wherein the lead lines are provided on the flexible member and are arranged to allow efficient connection of the plurality of sensors to the controller.
